(19) United States
(12) Patent Application Publication
(10) Pub. No.: US 2016/0147958 A1
(43) Pub. Date: May 26, 2016

(54) COMPUTERIZATION AND VISUALIZATION OF CLINICAL RULES AND DEFINITIONS FOR PATIENT MONITORING SYSTEMS

(71) Applicant: KONINKLIJKE PHILIPS N.V., Eindhoven (NL)

(72) Inventors: Srinivasan Vairavan, Ossining, NY (US); Caitlyn Marie Chiofolo, New Hyde Park, NY (US); Nicolas Wadin Chbat, White Plains, NY (US)

(21) Appl. No.: 14/905,050

(22) PCT Filed: Jul. 9, 2014
(86) PCT No.: PCT/IB2014/062967

§ 371 Date: Jan. 14, 2016

Related U.S. Application Data
(60) Provisional application No. 61/858,801, filed on Jul. 26, 2013.

(51) Int. Cl. G06F 19/00

(52) U.S. Cl. CPC G06F 19/345; G06F 19/322

(57) ABSTRACT

Using a computer communicating with an electronic medical record (EMR) system, an update in a patient EMR is automatically detected of a physiological parameter that is an input to an illness staging or evaluation clinical guideline. Responsive to detecting of the update of the physiological parameter, instructions are executed using the computer to evaluate the illness staging or evaluation clinical guideline using the updated physiological parameter as an input to the illness staging or evaluation clinical guideline to generate a guideline result. The guideline result is plotted as a function of time on a display device.

The following relates to the patient care arts, patient monitoring arts, and related arts.

A critically ill patient is typically admitted to a critical care facility such as an intensive care unit (ICU), cardiac care unit (CCU), neonatal unit, where the patient is continuously monitored by medical personnel to ensure early detection of incipient medical conditions that can be life-threatening or debilitating, such as acute kidney injury (AKI), pneumonia, congestive heart failure (CHF), acute respiratory failure (ARF), or systemic inflammatory response syndrome (SIRS). The monitoring performed in a critical care setting includes automated monitoring of vital signs such as heart rate, respiration, arterial blood pressure, and so forth, as well as scheduled collection of clinical data such as urinary output, blood sample analyses, and so forth. Nurses or other medical personnel are on-site continuously to monitor vital signs, and the electronic vital signs monitoring equipment also typically includes alarms and associated alarm thresholds that, for example, sound an alarm if the heart rate goes above an upper critical threshold or below a lower critical threshold. Clinical data are recorded in the patient electronic medical record and/or bedside chart as they become available. For example, a blood sample may be drawn every twelve hours (or on some other schedule), physician-prescribed laboratory tests performed on the blood sample, and the test results are then conveyed back to the critical care unit by electronically transferring data to the patient's electronic medical record at the blood test laboratory or by conveying the results manually to the ICU or other critical care facility where the results are manually entered into the patient record and/or bedside chart.

Each patient case is reviewed on a scheduled basis by a doctor assigned to the ICU or other critical care facility, e.g. daily or during each shift. Additionally, the patient's primary care (or attending) physician and possibly one or more specialists performs rounds at the hospital and reviews the patient case. These doctors make patient treatment decisions, and may prescribe (or modify prescription of) various pharmaceuticals, therapies, and so forth based on the patient's medical condition as evidenced by the medical record and/or bedside chart and the physician's examination of the patient.

A problem that can arise in diagnosing patients in the critical care setting is information overload, since the physician may be provided with a wide array of continuous charts plotting measured vital signs, tabulated laboratory test results, and so forth. To assist in diagnoses, clinical organizations such as the American Medical Association (AMA), the National Heart, Lung, and Blood Institute Acute Respiratory Distress Syndrome (NHLBI ARDS) Network, and the Acute Kidney Injury Network (AKIN), have developed clinical criteria for detection of critical illnesses such as acute myocardial infarction (AMI), acute respiratory distress syndrome (ARDS) and acute kidney injury (AKI) respectively. The clinical criteria attempt to distill the large quantity of available patient data into a concise diagnosis. For example, AKI guidelines developed by AKIN articulate three stages of AKI, defined in terms of serum creatinine (Cr) level and urine output (UO) level.

In spite of the foregoing, diagnosis of a life-threatening or debilitating disease in a patient in a critical care setting is problematic. Typically, the nursing staff is not authorized or trained to diagnose a critical illness or to modify prescribed treatment. Thus, the onset of a life-threatening illness can go untreated for hours, until the next scheduled visit by a physician. Even then, a diagnosis can be missed due to information overload characteristic of the critical care environment. Clinical guidelines can be useful to filter the information; however, if a guideline is based on infrequently recurring data then the guideline can actually introduce further delay. For example, if a clinical guideline relies upon a blood test result, then at the time of the visit the physician can only rely on the most recent blood test result, which (considering frequency of testing and the delay between blood draw, laboratory workup and communication of the result) may have been generated from a blood sample drawn many hours ago. Other drawbacks to guidelines include the need for the physician to be familiar with the latest versions of the various guidelines for different illnesses, and the need for the physician to be diligent in applying each guideline as appropriate. Applying clinical guidelines can also in some instances require performing relatively complex calculations (e.g., unit conversion, normalization by weight or the like), and any errors made in such calculations can produce an incorrect guideline result. These issues remain outstanding, even though the medical community recognizes that early diagnosis and treatment of an incipient life-threatening or debilitating illness can greatly enhance the prognosis.

The following contemplates improved apparatuses and methods that overcome the aforementioned limitations and others.

According to one illustrative aspect, a non-transitory storage medium stores instructions readable and executable by an electronic data processing device to: detect updates in a patient electronic medical record (EMR) of physiological parameters that are inputs to an illness staging or evaluation clinical guideline; respond to detection of an update in the patient EMR of a physiological parameter that is an input to the illness staging or evaluation clinical guideline by evaluating the illness staging or evaluation clinical guideline with the updated physiological parameter to generate a guideline result; and display the guideline result on a display device

According to another illustrative aspect, a system comprises: a display device; a non-transitory storage medium as set forth in the immediately preceding paragraph; and an electronic data processing device configured to read and execute the instructions stored on the non-transitory storage medium to display the guideline result on the display device.

According to another illustrative aspect, an acute kidney injury (AKI) monitoring system comprises a display device and an electronic data processing device programmed to define: an update detector configured to detect updates in a patient electronic medical record (EMR) of serum creatinine (Cr) level and urine output (UO); an AKI guideline evaluation engine configured to respond to detection by the update detector of an update in the patient EMR of serum Cr level or UO by evaluating an AKI staging or evaluation clinical guideline that is functionally dependent on serum Cr level and UO with the updated serum Cr level or UO to generate an AKI stage or evaluation result; and an AKI monitoring user interface configured to plot the AKI stage or evaluation result output by the AKI guideline evaluation engine as a function of time.

According to another illustrative aspect, a method comprises: using a computer communicating with an electronic medical record (EMR) system, automatically detecting an update in a patient EMR of a physiological parameter that is an input to an illness staging or evaluation clinical guideline; responsive to detecting the update of the physiological parameter, executing instructions using the computer to evaluate the illness staging or evaluation clinical guideline using the updated physiological parameter as an input to the illness staging or evaluation clinical guideline to generate a guideline result; and plotting the guideline result as a function of time on a display device.

One advantage resides in providing more rapid detection of a life-threatening or debilitating disease.

Another advantage resides in enabling the nursing staff of a critical care facility to recognize a life-threatening or debilitating disease without special training.

Numerous additional advantages and benefits will become apparent to those of ordinary skill in the art upon reading the following detailed description.

The invention may take form in various components and arrangements of components, and in various process operations and arrangements of process operations. The drawings are only for the purpose of illustrating preferred embodiments and are not to be construed as limiting the invention.

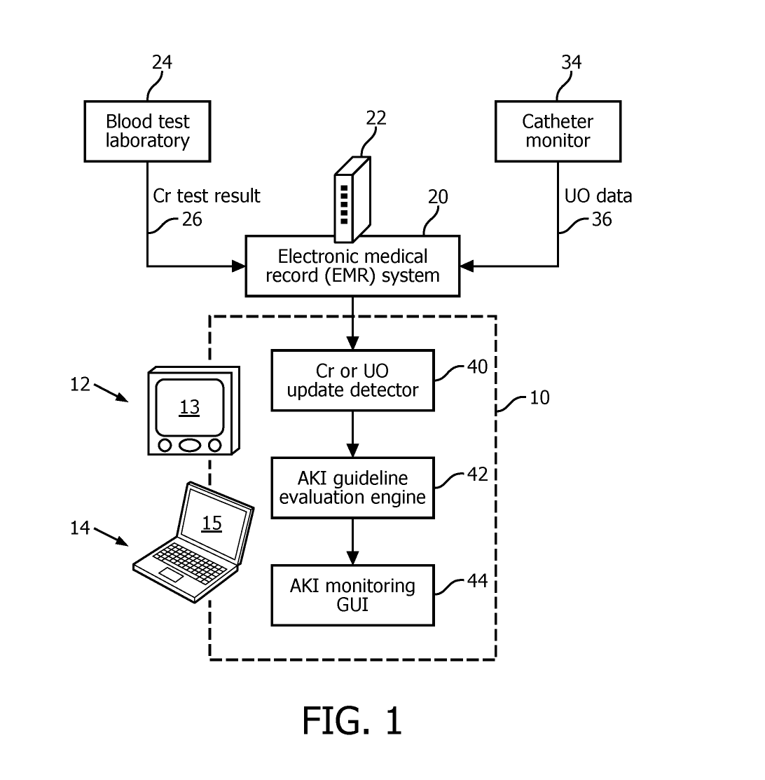

FIG. 1 diagrammatically shows a monitoring system for detecting and staging acute kidney injury (AKI).

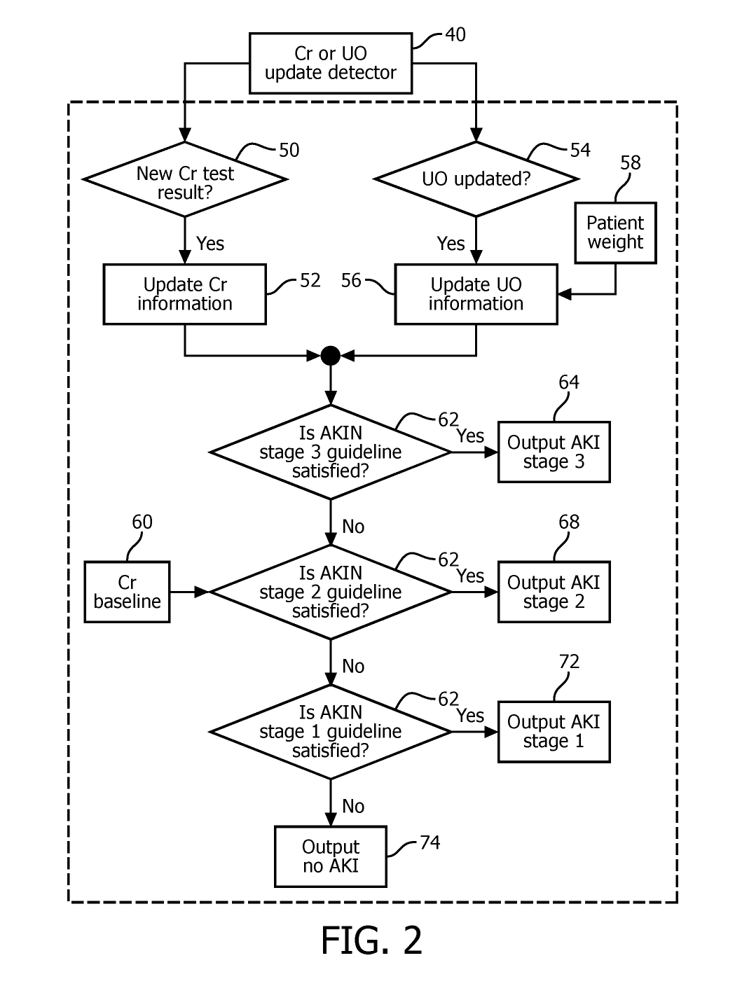

FIG. 2 diagrammatically shows a suitable embodiment of the AKI staging engine of the system of FIG. 1.

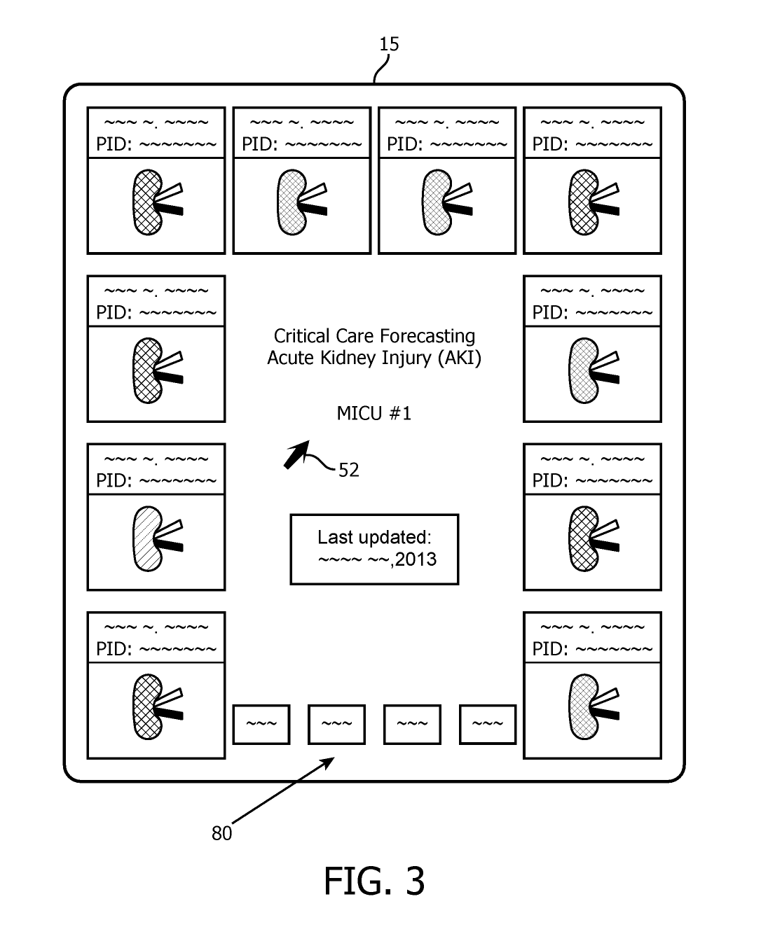

FIG. 3 diagrammatically shows a screenshot of a graphical user interface (GUI) for displaying AKI staging information for all patients in an intensive care unit (ICU).

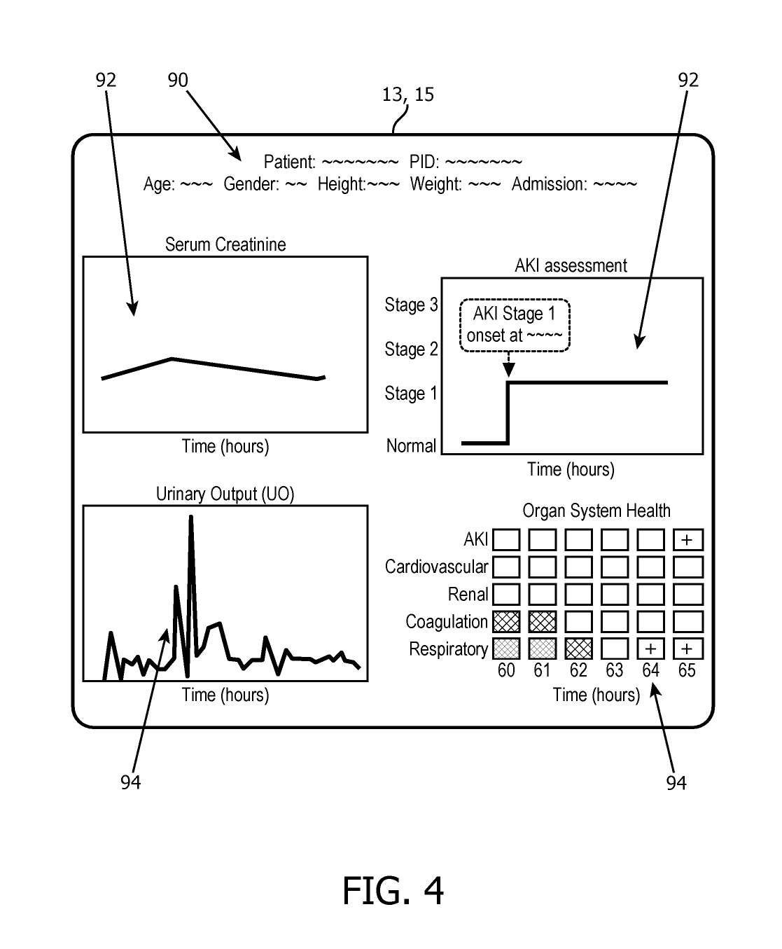

FIG. 4 diagrammatically shows a screenshot of a graphical user interface (GUI) for displaying AKI staging information for one patient.

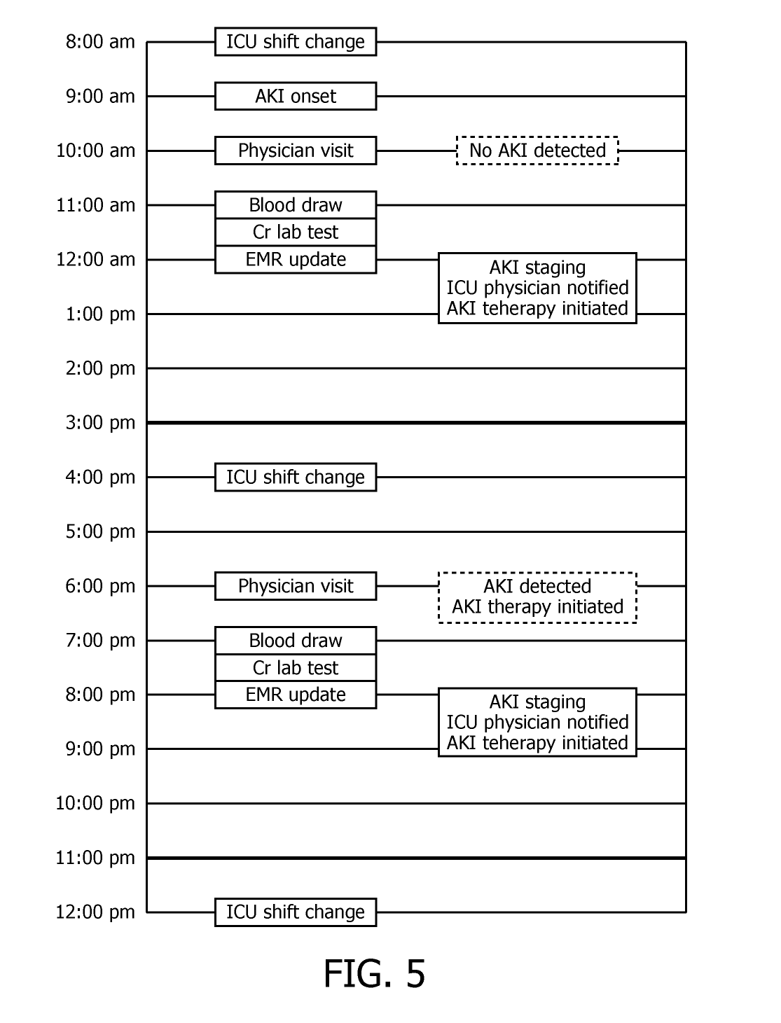

FIG. 5 diagrammatically shows a timeline including two eight-hour ICU shifts, illustrating effectiveness of the AKI monitoring system of FIG. 1 in reducing the delay between AKI onset and initiation of treatment.

With reference to FIG. 1, a monitoring system 10 for detecting and staging acute kidney injury (AKI) is illustrated. The AKI monitoring system 10 is implemented on an electronic data processing device that includes or accesses a display device, such as an illustrative bedside monitor 12 including a built-in display 13, or a nurses' station computer 14 with a computer monitor 15. The electronic data processing device 12, 14 includes a microprocessor or microcontroller and further includes or has access to ancillary components such as random access memory (RAM) and a hard disk drive, optical drive, flash memory, read-only memory (ROM), or other non-transitory storage medium or media (components not shown) storing instructions (e.g. software or firmware) readable and executable by the electronic data processing device 12, 14 to perform patient monitoring tasks as disclosed herein. The electronic data processing device 12, 14 is operatively connected with an electronic medical record (EMR) system 20 which is suitably hosted on a server 22 (optionally cloud-based) via a hospital data network (wired, wireless, or some combination of wired and wireless connections), the Internet, or so forth. The EMR system 20 receives and stores medical data relating to patients of a medical facility, with each patient having a corresponding electronic medical record (EMR) in the EMR system 20. In the illustrative examples the medical care facility is an intensive care unit (ICU), but more generally the medical care facility can be another type of critical care facility such as a cardiac care unit (CCU), neonatal care unit (NCU), or so forth, or may be a floor or other operational unit of a hospital or other medical facility that is not designated as a critical care unit. The AKI monitoring system 10 monitors one or more patients to detect, and optionally stage, AKI. In the illustrative embodiments, the AKI monitoring system 10 utilizes AKI staging guidelines promulgated by the Acute Kidney Injury Network (hereinafter “AKIN staging” or “AKIN guideline”). See Mehta et al., “Acute Kidney Injury Network: report of an initiative to improve outcomes in acute kidney injury”, Critical Care 2007, volume 11:R31 (available online at http://ccforum.com/content/11/2/R31). The use of other AKI guidelines is also contemplated. The illustrative AKIN staging employs two inputs: blood serum creatinine (Cr) and urinary output (UO).

In the illustrative system of FIG. 1, a diagrammatically indicated blood test laboratory 24 receives a blood sample drawn from a patient in the ICU and performs a blood workup that includes measuring the serum Cr concentration, for example expressed in milligrams/deciliter (mg/dL) or micromoles/liter (μmol/L). In the illustrative examples herein, serum Cr concentration 26 generated by the blood test is expressed in mg/dL, and this value is entered into the patient EMR manually or electronically. It will be appreciated that such a blood test is performed on a scheduled basis, typically in accord with hospital or ICU operational guidelines or patient-specific instructions prescribed by a doctor. In a typical ICU or other critical care facility, for an average patient, blood is drawn between one and three times per day, and there is a delay of about 30 minutes or longer between the time that the blood sample is drawn and the time that the blood workup is completed and the Cr concentration (and optionally other results of the blood workup) are entered into the patient EMR.

In illustrative FIG. 1, the patient is assumed to be on a urinary catheter. Such a device typically includes a catheter monitor 34 that monitors urinary output (UO) and generates a UO data 36, which may take various forms. In the illustrative embodiment the UO data 36 are assumed to be expressed in units of milliliters/hour (ml/hr), with a urinary datum in ml generated once every hour and recorded in the patient EMR. In other embodiments, the patient may not be on a catheter, in which the UO data are suitably generated manually, for example by a nurse recording the fluid volume in a graduated urinal employed by the patient on an hourly or other time basis.

The illustrative AKI monitoring system 10 operates as follows. A Cr or UO update detector 40 is in operative communication with the EMR system 20 to detect receipt and recordation in the patient EMR of a new Cr test result 26 or UO data 36 for the patient undergoing AKI monitoring using the system 10. The update detector 40 can operate, for example, by storing the time stamp of the last-detected Cr test result and checking the Cr data structure (e.g. column in a relational database or spreadsheet, et cetera) on a per-second basis or faster to detect a more recent Cr test result substantially simultaneously with (e.g. within one second of) its recordation in the patient EMR; and similarly storing the time stamp of the last-detected UO datum and checking the UO data structure to detect a more recent UO datum substantially simultaneously with its recordation in the patient EMR.

As an electronic data processing component, the update detector 40 can check for new values recorded in the EMR on a frequent basis, e.g. every second or faster in some contemplated embodiments. Upon detection of a Cr or UO update by the update detector 40, an AKI guideline evaluation engine 42 is invoked which updates the AKI staging for the patient based on the new Cr test result and/or new UO datum. The AKI guideline evaluation engine 42 comprises the electronic data processing device 12, 14 executing programming to perform the AKIN staging guideline (in the illustrative example). It is to be understood that “responsive to” as used herein encompasses embodiments in which there is some delay between the detection of a Cr or UO update and the responsive AKI staging. For example, the AKI guideline evaluation engine 42 may be programmed to run on a per-minute or every fifteen minute basis (as two examples), conditional on (i.e. responsive to) the update detector 40 having detected a Cr or UO update in the previous minute or 15 minutes, respectively. AKIN staging produces an output selected from the set {no AKI, Stage 1 AKI, Stage 2 AKI, Stage 3 AKI}. The AKIN staging guideline for AKI stage 1 includes a Cr prong suitably expressed as:

Increase in Cr≧0.3mg/dL OR Increase in Cr≧1.5×baseline (1)

where “baseline” denotes a Cr baseline which can be variously defined, for example as a serum Cr concentration measured for the patient within the 6 months prior to admission into the hospital, or as a reference value defined using the Modification of Diet in Renal Disease (MDRD) function or another model. The AKIN staging guideline for AKI stage 1 also includes a UO prong (normalized by patient's body weight (kg)) suitably expressed as:

UO<0.5 ml/kg/h for ≧6hours (2)

Under the AKIN guideline, a patient is considered to have stage 1 AKI if either the Cr prong (Expression (1)) or the UO prong (Expression (2)), or both, are satisfied.

The AKIN staging guideline for AKI stage 2 includes a Cr prong suitably expressed as:

Increase in Cr≧2×baseline (3)

and a UO prong suitably expressed as:

UO<0.5 ml/kg/h for ≧12 hours (4)

A patient is considered to have stage 2 AKI if either the Cr prong (Expression (3)) or the UO prong (Expression (4)), or both, are satisfied.

The AKIN staging guideline for AKI stage 3 includes a Cr prong suitably expressed as:

Increase in Cr≧3×baseline OR Cr≧4 mg/dL with a rise of 0.5 mg/dL (5)

and a UO prong suitably expressed as:

UO<0.3 ml/kg/h for >24 hours OR Anuria (UO<50 ml) for ≧12 hours (6)

A patient is considered to have stage 3 AKI if either the Cr prong (Expression (5)) or the UO prong (Expression (6)), or both, are satisfied.

If none of Expressions (1)-(6) is satisfied, then the patient is designated as not having AKI. It may also be noted that any time the patient undergoes renal replacement therapy (RRT), the AKIN guidelines define such a patient as being in stage 3 AKI; however, this is not implemented in the illustrative AKI guideline evaluation engine 42, or alternatively is implemented using presence of dialysis parameters (such as dialysate flow rate, dialysate solution, CRRT worksheet balance, etc.) or alternatively is implemented by a manual operation (not shown) by which a physician or other authorized medical person can manually set the output to AKI stage 3.

In other embodiments, the AKI guideline evaluation engine 42 may not perform multi-level staging but rather may only identify whether or not the patient has AKI. In one such approach, the stage 1 AKIN guideline is used to identify the patient as either having AKI (if one or both of Expressions (1) and (2) is satisfied) or not having AKI (if neither of Expressions (1) and (2) are satisfied). In another approach, AKI is present if any of Expressions (1) through (6) is satisfied or if RRT is initiated and AKI is absent if none of Expressions (1) through (6) is satisfied and RRT is not initiated. These are merely illustrative examples, and other staging guidelines for assessing whether a patient has AKI are also contemplated. It should also be noted that the output of the AKI guideline evaluation engine 42 is typically treated merely as a recommended diagnosis, which may be overridden by a physician based on the physician's medical expertise. Such a “manual override” can optionally be incorporated into the AKI monitoring system 10, for example by providing a user input mechanism by which an authorized user can manually designate the AKI status of the patient, or alternatively is not included in the monitoring system 10 but rather is implemented in the ICU by other means, such as by way of the physician providing suitable instructions in the patient EMR and/or by suitable physician annotation on the patient's bedside chart. A chronic kidney disease (CKD) patient might be one such example of a case where “manual override” can be initiated to ignore AKI indications for a patient already known to have CKD.

With continuing reference to FIG. 1, the AKI monitoring system 10 further includes an AKI monitoring user interface 44, which in the illustrative example is a graphical user interface (GUI). The AKI monitoring GUI 44 informs medical personnel of whether the patient has AKI according to the AKI guideline evaluation engine 42 and, optionally, the AKI stage indicated by the AKI guideline evaluation engine 42.

With reference to FIG. 2, an illustrative embodiment of the AKI guideline evaluation engine 42 is described. When the update detector 40 detects an update, it is first determined which of the inputs (Cr or UO, or possibly both) has been updated. In a decision operation 50, it is determined whether a new Cr test result 26 has been logged in the patient EMR. If so, then in an operation 52 the Cr information for use in the AKIN staging is updated. In a decision operation 54, it is determined whether a new UO datum 36 has been logged in the patient EMR. If so, then in an operation 56 the UO information for use in the AKIN staging is updated. This update 56 entails normalizing the UO datum 36 by the patient weight 58 (which is typically available from the patient EMR), if the datum is not already weight-normalized as output by the catheter monitor 34. In some embodiments the setup of the EMR system 20 and the frequency of update checking performed by the update detector 40 are such that in any given iteration only one of Cr and UO may be updated. In other embodiments, it may be possible to update both Cr and UO in the patient EMR simultaneously.

The AKI guideline evaluation engine 42 also employs as input the Cr baseline 60 for the patient in evaluating the Cr prongs of the AKIN staging (Expressions (1), (3), and (5)). The AKI guideline evaluation engine 42 evaluates whether the patient is at AKI stage 3 in an operation 62 which uses Expressions (5) and (6). If Expression (5) or Expression (6) is satisfied (or if both expressions are satisfied), then the operation 60 outputs AKI Stage 3 64 as the staging result and the staging processing terminates. If neither Expression (5) nor Expression (6) is satisfied, then process flow moves to an operation 66 which uses Expressions (3) and (4) to evaluate whether the patient is at AKI Stage 2. If so, then the operation 66 outputs AKI Stage 2 68 as the staging result and the staging processing terminates. If neither Expression (3) nor Expression (4) is satisfied, then process flow moves to an operation 70 which uses Expressions (1) and (2) to evaluate whether the patient is at AKI Stage 1. If so, then the operation 70 outputs AKI Stage 1 72 as the staging result and the staging processing terminates. If neither Expression (1) nor Expression (2) is satisfied, then the operation 70 outputs no AKI 74 as the result and the staging processing terminates.

It will be appreciated that the AKI staging approach diagrammatically shown in FIG. 2 is illustrative, and other implementations of the AKIN guideline can be employed. For example, in an alternative process flow all three operations 62, 66, 70 can be executed in any order, and the output is the highest stage. As another alternative, if it is desired merely to detect AKI but not to perform multi-level staging, then the operations 62, 66 may be omitted and only operation 70 is performed. (This approach is effective since if the patient satisfies the AKIN criteria for Stage 2 or Stage 3 then the patient also satisfies the AKIN criteria of Expressions (1) and/or (2) for Stage 1).

With reference to FIGS. 3 and 4, some illustrative embodiments of the AKI monitoring GUI 44 of FIG. 1 are described. In FIGS. 3 and 4, patient-specific data are represented diagrammatically by tildes (“˜˜˜”). FIG. 3 illustrates an ICU-level display suitably shown on the display device 15 of the nurses' station computer 14. In an AKI overview screen shown in FIG. 3, each patient of the ICU is represented by a diagrammatic block including patient information, e.g. a unique patient identifier (PID) assigned to the patient at the time of patient admission, and a graphical representation of the AKI status which in the illustrative example is an icon representing a kidney having a color or other feature indicating AKI status. In FIG. 3, different colors (or features) of the kidney icons of different patients are diagrammatically represented by different cross-hatch patterns. In one embodiment: patients at AKI Stage 3 are represented by kidney icons colored red and flashing; patients at AKI Stage 2 are represented by kidney icons colored red without flashing; patients at AKI Stage 1 are represented by kidney icons colored yellow without flashing; and patients without AKI are represented by kidney icons colored green (or alternatively clear, i.e. no flashing) without flashing. Other color choices or other features are also contemplated. As another example: patients at AKI Stage 3 are represented by kidney icons colored red; patients at AKI Stage 2 are represented by kidney icons colored orange; patients at AKI Stage 1 are represented by kidney icons colored yellow; patients without AKI are represented by kidney icons colored green or clear; and flashing is used to indicate a patient who has just transitioned from a state of lower criticality to a state of higher criticality (that is, from no AKI to Stage 1; or from Stage 1 to Stage 2; or from Stage 2 to Stage 3). In some embodiments, the layout of the diagrammatic blocks representing the patients mimics the floor layout of the ICU. The illustrative overview display of FIG. 3 provides other information such as a centrally located textual title, a “Last updated” box, and a set of control buttons or other control dialog features 80 located at bottom. These control buttons may, for example, allow a nurse to switch to an overview display for another life-threatening or debilitating illness such as congestive heart failure (CHF), acute respiratory failure (ARF), Systemic Inflammatory Response Syndrome (SIRS), or so forth. A button is suitably activated by pointing to it using a mouse pointer 82, or by touching the button with a finger if the display 15 is a touch-sensitive display device, or by another user interfacing mechanism.

With continuing reference to FIG. 3 and with reference now turning to FIG. 4, if a nurse selects one of the diagrammatic blocks representing a patient (e.g. using the mouse pointer 82 or a finger on a touch-sensitive display) then a patient AKI status screen shown in FIG. 4 is brought up on the display 15 of the nurses' station computer 14. Additionally or alternatively, the screen shown in FIG. 4 may be shown on the display 13 of the bedside monitor 12 assigned to the patient's room and bedside. The illustrative patient AKI status screen shown in FIG. 4 includes a patient information section 90 showing patient information such as name, PID, age, gender, height, weight, et cetera. This information is suitably drawn from the patient EMR. A window 92 plots serum creatinine test results 26 for the last several blood draws, as a function of time on the abscissa. A window 94 plots urinary output data 36 as a function of time on the abscissa. Although not illustrated in FIG. 4, it is contemplated to depict various thresholds of the Expressions (1), (3), and (5) in the Cr plot 92, and/or to depict various thresholds of the Expressions (2), (4), and (6) in the UO plot 94.

With continuing reference to FIG. 4, in an AKI status plot 96 is displayed in the upper right of the screen. The illustrative AKI status plot 96 includes the states “no AKI”, “Stage 1”, “Stage 2”, and “Stage 3” as the ordinate values, and time as the abscissa. In the illustrative example, the data show a transition from “No AKI” to “Stage 1” about one-third of the way along the abscissa. The transition is labeled “AKI Stage 1 onset at ˜˜˜” where the tildes diagrammatically indicate a timestamp of the detection of Stage 1. The label shown in the plot 96 is optionally displayed as a pop-up balloon or other GUI display feature. Alternatively, the onset timestamp may be stored in the patient EMR but not labeled on the plot 96.

The illustrative patient AKI status screen shown in FIG. 4 also includes an organ system health window 98 in which diagrammatic blocks are color-coded or otherwise featured to represent the state of various organs or systems, such as in the illustrative window 98 blocks for AKI (which is also the subject of the windows 92, 94, 96), the cardiovascular system, the renal system, the coagulation system, and the respiratory system. These systems are listed along the vertical axis of the window 98, and the horizontal axis represents the last several hours, so that each block represents the state of the system designated by the vertical position of the block at an hour designated by the horizontal position of the block. In the illustrative window 98, blocks marked by a plus sign (“+”) correspond to the condition of the system represented by the block increasing in severity. The organ system health window 98 is a suitably succinct representation of sequential organ failure assessment (SOFA) scores for the several organs/systems.

The GUI screens shown in FIGS. 3 and 4 are merely illustrative examples, and other representations may be employed. In some embodiments, the overview screen of FIG. 3 may be omitted. In addition to visual indicia, it is also contemplated to employ an audible alarm component for certain transitions, e.g. when the patient transitions from “No AKI” to Stage 1 or from a lower stage to a higher stage.

The AKI status monitoring system 10 described with illustrative reference to FIGS. 1-4 is an example, and the approach can be applied to monitor substantially any type of life-threatening or debilitating illness of interest to ICU medical personnel. The approach in each case is to monitor the EMR system 20 for recordation of new values for relevant physiological parameters (that is measurable parameters of a patient characterizing the patient's condition, such as vital signs, blood test results, urine output, et cetera) that serve as input to the clinical guideline or staging guideline (i.e. analogous to the Cr/UO update detector 40 of FIG. 1). Responsive to a new datum being recorded in the patient EMR, an illness staging or evaluation engine (analogous to the AKI guideline evaluation engine 42 of FIG. 1) computes the guideline result for the new input value(s), and a suitable user interface (analogous to the AKI monitoring GUI 44 of FIG. 1) displays the updated illness staging or evaluation result. Some illustrative examples for other illnesses besides AKI are set forth below.

In the case of acute respiratory failure (ARF), there is insufficient oxygenation of the arterial blood (a condition also known as hypoxemia). In some clinical guidelines (see, e.g. Maffessanti et al., “Thoracic Imaging in the Intensive Care Unit”, Diseases of the Heart, Chest & Breast (Diagnostic Imaging and Interventional Techniques. Edited by J. Hodler, G. V. von Schulthess, Ch. Zollikofer, Springer), ARF is categorized using the partial pressure of oxygen in blood (PaO₂) and partial pressure of carbon dioxide in blood (PaCO₂). In one suitable guideline (see Id.), the ARF is staged as: normal (PaO₂<60 mmHg); mild (PaO₂ in the range 60-69 mmHg); moderate (PaO₂ in the range 50-59 mmHg); or severe (PaO₂<50 mmHg). ARF is also diagnosed by the guideline if PaCO₂>45 mm Hg. Thus, for an ARF monitor, the update detector monitors for updates of PaO₂ or PaCO₂, the staging engine applies the foregoing clinical rules, and the user interface outputs ARF status as normal, mild, moderate, or severe.

For some illnesses, direct staging may be difficult. The goal of the illness monitor is to provide sufficient information to alert the ICU nurse to call the ICU doctor (or the patient's primary care physician or relevant specialist, et cetera) to evaluate the patient. Thus, for example, in the case of Systemic Inflammatory Response Syndrome (SIRS), which is a common precursor to sepsis, some clinical guidelines (see, e.g. Bone et al., “Definitions for Sepsis and Organ failure and guidelines for the use of innovative therapies in sepsis”, Chest, vol 101, Issue 6, June 1992, pp: 1644-1655) call for monitoring four vital signs: temperature (below 36° C. or above 38° C. being an indicator of SIRS), heart rate (greater than 90 beats per minute being an indicator of SIRS), respiratory issues (respiratory rate greater than 20 breaths per minute or PaCO₂<32 mmHg being an indicator of SIRS), and white blood cell count (≧12,000 or ≦4,000 cells/mm² or >10% bands being an indicator of SIRS). Thus, a suitable SIRS monitor operates as follows. The update detector monitors for updates of temperature, heart rate, respiratory rate, PaCO₂, and white blood cell count. Upon detecting a change in any of these vital signs as recorded in the patient EMR, the SIRS clinical rule for that vital sign is evaluated using the new data. The user interface displays the status for the four vitals: temperature, heart rate, respiratory state, and white blood cell count, and outputs an alarm (e.g. flashing red indicator) if one of the vitals takes on a value indicating the possibility of incipient SIRS.

Monitoring for congestive heart failure (CHF) is considered as a further example. In this case, pulmonary capillary wedge pressure (PCWP) is typically employed as the vital sign for staging CHF. See, e.g http://www.radiologyassistant.nl/en/p4c132f36513d4. One CHF clinical staging guideline (see Id.) labels the following stages of CHF: No CHF (PCWP<13 mmHg); Stage 1 (PCWP in the range 13-18 mmHg); Stage 2 (PCWP in the range 18-25 mmHg); and Stage 3 (PCWP>25 mmHg). Additionally, serum natriuretic peptide values are often considered to be correlative with CHF, although not sufficiently correlative for direct staging. In one CHF evaluation approach (see, e.g. http://www.gpnotebook.co.uk/simplepage.cfm?ID=x20101014150323274950), serum natriuretic peptide levels are classified as follows: High levels (BNP>400 pg/ml or NTproBNP>2000 pg/ml); Raised levels (BNP in the range 100-400 pg/ml or NTproBNP in the range 400-2000 pg/ml); and normal levels (BNP<100 pg/ml or NTproBNP<400 pg/ml). Thus, in a suitable CHF monitor, the update detector monitors for updates of PCWP, serum BNP level, or serum NTproBNP level. Upon detecting a change in PCWP as recorded in the patient EMR, CHF is staged based on the updated PCWP, and the user interface displays the updated CHF staging. Upon detecting a change in BNP or NTproBNP, the level (normal, raised, or high) for that natriuretic peptide is assessed and displayed. Red indicators or other alarm indication is shown if the CHF staging is not normal or if BNP or NTproBNP is at a raised or high level.

With returning reference to FIG. 3, it will be appreciated that various monitors, e.g. for AKI, ARF, SIRS, and/or CHF, can be implemented on a single electronic data processing device (e.g. on the nurses' station computer 14). To enable rapid switching between overview screens for the various illnesses, the control buttons 80 can include selections for overview screens for different illnesses, e.g. in the AKI overview display of FIG. 3 the buttons 80 may include control buttons to switch to an ARF overview screen, to a SIRS overview screen, or to a CHF overview screen. It is also contemplated to switch automatically to a given illness overview screen if the status of any patient respective to that illness changes. As another variant embodiment, a single overview screen can be employed, but with the diagrammatic block representing each patient including multiple icons for various monitored diseases. For example, in addition to the kidney icon for each patient shown in the AKI overview screen of FIG. 3, a suitable ARF icon (e.g. showing a set of lungs) can be color-coded to indicate ARF condition. As another example, a SIRS icon can be color-coded, e.g.: a green icon if temperature, heart rate, respiratory state, and white blood cell count are all in their normal ranges; a yellow icon if one of these vital signs is outside its normal range; and a red icon if two or more of these vital signs are outside of their respective normal ranges.

The disclosed illness monitors operate by detecting a new recorded value for an input (e.g. an input vital sign) to a clinical staging or assessment guideline for the illness and, responsive to detecting such a new value, reevaluating the guideline and displaying the result. In the case of many illnesses, such as AKI, the input vital sign is updated on a very infrequent basis. For the AKI example, Cr is updated typically one to three times per day (corresponding to drawn blood samples throughout the day), while UO is updated typically on an hourly basis for a catheterized patient and even less frequently for a patient who is not on a catheter. More generally, while some clinical guideline parameters may be updated frequently (e.g. in real-time in the case of heart rate, respiratory rate, or body temperature), some clinical guideline input parameters may be updated less frequently, e.g. less frequently than once every 15 minutes, or less frequently than once per hour. In cases of infrequent input parameter updates (e.g. 15 minutes or longer between updates, or an hour or more between updates), it might be expected that the disclosed recordation update-triggered automatic illness staging or evaluation is not of value, since the update recordations are infrequent events.

However, with reference to FIG. 5 it is demonstrated that in practice the disclosed monitoring provides substantial benefit especially in the case of infrequent input value recordation-triggered updating. FIG. 5 illustrates a typical ICU timeline. In this typical illustrative example, the ICU runs on three eight-hour shifts: 8:00 am-4:00 pm; 4:00 pm-midnight; and midnight-8:00 am. As is also typical, during each shift the ICU physician evaluates each patient once. In the illustrative example, the patient is evaluated by the ICU physician at 10:00 am and in the next 8-hour shift at 6:00 pm. Blood is also drawn one time per shift, in the illustrative example at 11:00 am and in the next shift at 7:00 pm. In the illustrative example the patient experiences the onset of Stage 1 AKI at 9:00 am. Accordingly, the blood sample drawn earlier (e.g. at 3:00 am the previous night) will not evidence the AKI, and moreover UO will not evidence the AKI for at least six hours, i.e. not until 3:00 p.m. (see Expression (2)).

In this situation, when the ICU physician visits at 10:00 a.m., he or she will likely not be able to detect the AKI onset that occurred at 9:00 a.m. This is true even if the physician were to go through the process of manually applying the AKIN guideline rules, because at 10:00 a.m. neither the last-available Cr reading nor the UO output over the last six hours would evidence the AKI onset at 9:00 a.m. As a consequence, the AKI onset at 9:00 a.m. would likely not be detected until the time of the second-shift ICU physician visit at 6:00 p.m.—assuming that physician is diligent and applies the AKIN guidelines to the Cr test result generated by the 11:00 a.m. blood draw. This means the patient would go a full nine hours between the AKI onset and its detection and the initiation of AKI therapy.

By contrast, consider the case when using the AKI monitor described with illustrative reference to FIGS. 1-4. Assuming that the blood workup and recordation in the patient EMR takes about one hour, it follows that the Cr test result generated from the blood draw taken at 11:00 a.m. will be recorded in the patient EMR at about 12:00 p.m. (i.e. at about noon). The update detector 40 immediately detects this new Cr test result, and invokes the AKI guideline evaluation engine 42 which detects that the patient is in AKI Stage 1 based on evaluation of Expression (1) in decision operation 70, and the AKI monitoring GUI 44 displays an alarm (and optionally raises an audible alarm) at the nurses' station computer 14. Thus, the nurse is made aware of the possible onset of AKI at about noon, notifies the on-call ICU physician who reviews the latest Cr test result and prescribes the initiation of AKI therapy. In this case, only about three hours pass between AKI onset at 9:00 am and therapy initiation around noon; as compared with about nine hours when the AKI monitoring system is not used. (The delay of AKI treatment could be even longer than nine hours if, for example, the second-shift ICU physician fails to assess the patient for AKI using the AKIN guidelines and/or the physician's critical care expertise).

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A non-transitory storage medium storing instructions readable and executable by an electronic data processing device to:
detect updates in a patient electronic medical record (EMR) of physiological parameters that are inputs to an illness staging or evaluation clinical guideline;
respond to detection of an update in the patient EMR of a physiological parameter that is an input to the illness staging or evaluation clinical guideline by evaluating the illness staging or evaluation clinical guideline with the updated physiological parameter to generate a guideline result; and
display the guideline result on a display device.

2. The non-transitory storage medium of claim 1 wherein the illness staging or evaluation clinical guideline is an acute kidney injury (AKI) staging or evaluation clinical guideline and serum creatinine hereinafter Cr level and urine output, hereinafter UO are inputs to the AKI staging or evaluation clinical guideline.

3. The non-transitory storage medium of claim 2 wherein the evaluating of the AKI staging or evaluation clinical guideline includes weight-normalizing the UO by a weight of the patient and comparing the Cr level with a baseline Cr level for the patient.

4. The non-transitory storage medium of claim 1 wherein the illness staging or evaluation clinical guideline is an acute respiratory failure hereinafter ARF staging or evaluation clinical guideline and partial pressure of oxygen in blood, hereinafter PaO₂ and partial pressure of carbon dioxide in blood hereinafter PaCO₂ are inputs to the ARF staging or evaluation clinical guideline.

5. The non-transitory storage medium of claim 1 wherein:
the illness staging or evaluation clinical guideline is a systemic inflammatory response syndrome hereinafter SIRS evaluation clinical guideline, and
temperature, heart rate, respiratory rate, and white blood cell count are inputs to the SIRS evaluation clinical guideline, and
the evaluating of the SIRS evaluation clinical guideline generates a guideline result comprising indications of whether each of the temperature, heart rate, respiratory rate, and white blood cell count are outside of respective normal ranges.

6. The non-transitory storage medium of claim 1 wherein:
the illness staging or evaluation clinical guideline is a congestive heart failure CHF staging or evaluation clinical guideline, and
pulmonary capillary wedge pressure, hereinafter PCWP and at least one serum natriuretic peptide level are inputs to the CHF staging or evaluation clinical guideline, and
the evaluating of the CHF staging or evaluation clinical guideline to generate a guideline result includes computing a CHF staging result based on the PCWP and computing a natriuretic peptide level category based on the at least one serum natriuretic peptide level.

7. The non-transitory storage medium of claim 1 wherein the illness staging or evaluation clinical guideline is one of:
an acute kidney injury, hereinafter AKI staging or evaluation clinical guideline,
an ARF staging or evaluation clinical guideline,
a SIRS evaluation guideline, and
a CHF staging or evaluation clinical guideline.

8. The non-transitory storage medium of any one of claim 1 wherein physiological parameters that are inputs to the illness staging or evaluation clinical guideline are updated in the patient EMR no more frequently than once per 15 minutes.

9. A system comprising:
a display device;
a non-transitory storage medium as set forth in any one of claim 1; and
an electronic data processing device configured to read and execute the instructions stored on the non-transitory storage medium to display the guideline result on the display device.

10. (canceled)

11. The system of claim 9 wherein the electronic data processing device is a nurses' station computer monitoring a plurality of patients and configured to display the guideline results for the plurality of patients on the display device simultaneously with each patient represented by a diagrammatic block having color coding representing the guideline result for the patient.

12. (canceled)

13. An acute kidney injury AKI monitoring system comprising:
a display device; and
an electronic data processing device programmed to define:
an update detector configured to detect updates in a patient electronic medical record, hereinafter EMR of serum creatinine Cr level and urine output, hereinafter UO;
an AKI guideline evaluation engine configured to respond to detection by the update detector of an update in the patient EMR of serum Cr level or UO by evaluating an AKI staging or evaluation clinical guideline that is functionally dependent on serum Cr level and UO with the updated serum Cr level or UO to generate an AKI stage or evaluation result; and
an AKI monitoring user interface configured to plot the AKI stage or evaluation result output by the AKI guideline evaluation engine as a function of time.

14. (canceled)

15. (canceled)

16. A method comprising:
using a computer communicating with an electronic medical record, hereinafter system, automatically detecting an update in a patient EMR of a physiological parameter that is an input to an illness staging or evaluation clinical guideline;
responsive to detecting the update of the physiological parameter, executing instructions using the computer to evaluate the illness staging or evaluation clinical guideline using the updated physiological parameter as an input to the illness staging or evaluation clinical guideline to generate a guideline result; and
the guideline result on a display device.

17. The method of claim 16 wherein:
the illness staging or evaluation clinical guideline is an acute kidney injury, hereinafter AKI staging or evaluation clinical guideline having serum creatinine, hereinafter Cr, level and urine output UO, as inputs; and
the automatic detecting detects an update in the patient EMR of one of serum Cr level and UO.

18. The method of claim 17 wherein the executing evaluates the AKI staging or evaluation clinical guideline by operations including weight-normalizing the UO by a weight of the patient and comparing the serum Cr level with a baseline Cr level for the patient.

19. The method of claim 16 wherein:
the illness staging or evaluation clinical guideline is an acute respiratory failure, hereinafter ARF staging or evaluation clinical guideline having partial pressure of oxygen in blood, hereinafter PaO₂ and partial pressure of carbon dioxide in blood, hereinafter PaCO₂ as inputs; and
the automatic detecting detects an update in the patient EMR of one of PaO₂ and PaCO₂.

20. (canceled)
